(19) United States
(12) Patent Application Publication
(10) Pub. No.: US 2019/0039024 A1
(43) Pub. Date: Feb. 7, 2019

(54) MIXED MATRIX MEMBRANE FILTRATION DEVICE FOR AN APPLIANCE

(71) Applicant: Haier US Appliance Solutions, Inc., Wilmington, DE (US)

(72) Inventors: Anirban Roy, Hyderabad (IN); Srinivas Pasham, Hyderabad (IN); Sharath Chandra S, Hyderabad (IN); Pampana Vamsi Krishna, Hyderabad (IN); Naresh Suthar, Hyderabad (IN); Sasikumar Madanagopal, Hyderabad (IN); Andrew Reinhard Krause, Louisville, KY (US); Gregory Sergeevich Chernov, Louisville, KY (US)

(21) Appl. No.: 15/666,913

(22) Filed: Aug. 2, 2017

(51) Int. Cl. B01D 63/04; B01D 69/14; B01D 63/02; B01D 69/02; B01D 71/02; B01D 71/68; B01D 71/42; C02F 1/44; C02F 1/28

(52) U.S. Cl. CPC B01D 63/04; C02F 2101/345; B01D 63/024; B01D 69/02; B01D 71/021; B01D 71/022; B01D 71/68; B01D 71/42; C02F 1/44; C02F 1/281; C02F 1/283; B01D 2325/12; B01D 2319/04; B01D 2313/21; B01D 2313/20; B01D 69/147

(57) ABSTRACT

A filtration device includes features for robust filtering capability. In particular, the filtration device includes a filter medium having mixed matrix membranes that include hollow fiber membranes embedded with adsorbents such that the filter medium provides both mechanical and adsorption capability.

### FIELD OF THE INVENTION

The present subject matter relates generally to filter assemblies, and more particularly to filter assemblies for consumer appliances.

### BACKGROUND OF THE INVENTION

Certain water filter assemblies for appliances include a manifold and a filtration device. The manifold directs unfiltered water into the filtration device and filtered water out of the filtration device. Filter devices generally include a filter medium disposed within a housing for filtering the water passing or circulating therethrough. Conventional filter mediums include activated carbon blocks, pleated polymer sheets, spun cord materials, and melt blown materials.

Conventional filter mediums generally filter liquid based on either particle size or adsorption. Conventional filter mediums that mechanically filter liquid based on particle size can be ineffective at capturing harmful small particles due to the limitations of the porous medium. Conventional filter mediums that filter liquid based on adsorption can be ill equipped to remove certain pollutants, such as e.g., arsenic, cadmium, chromium, phenols, and other heavy metals and/or metalloids as such conventional filter mediums are generally only able to filter particular impurities and pollutants that they are chemically designed to capture. Thus, conventional filter mediums may fail to filter certain harmful particles from the liquid.

In addition, conventional filter mediums are generally granular in nature and therefore only allow for fluid flow in a particular direction, such as e.g., out-to-in or in-to-out. This may constrain the structural design of the filter assembly.

Accordingly, a filtration device that addresses one or more of the noted challenges would be useful.

### BRIEF DESCRIPTION OF THE INVENTION

The present subject matter provides a filtration device that includes features for robust filtering capability. In particular, the filtration device includes a filter medium having mixed matrix membranes that include hollow fiber membranes embedded with adsorbents such that the filter medium provides both mechanical and adsorption capability. Additional aspects and advantages of the invention will be set forth in part in the following description, or may be apparent from the description, or may be learned through practice of the invention.

In one exemplary aspect, a filtration device for an appliance is provided. The filtration device defines an axial direction and an axial centerline extending along the axial direction. The filtration device includes a housing defining an interior volume and defining an inlet for allowing a flow of fluid into the filtration device and defining an outlet for allowing a flow of fluid out of the filtration device. The filtration device further includes a filter medium assembly disposed within the interior volume of the housing. The filter medium assembly has a filter medium in fluid communication with the inlet and the outlet. The filter medium extends between a top end and a bottom end along the axial direction. The filter medium includes a potted medium. The filter medium further includes a plurality of mixed matrix membranes dispersed within the potted medium. The mixed matrix membranes include a plurality of hollow fiber membranes and one or more adsorbents embedded within the hollow fiber membranes. Each mixed matrix membrane extends along the axial direction a portion of a length of the filter medium and each mixed matrix membrane converges along the radial direction toward the axial centerline proximate the bottom end.

In some exemplary embodiments, the filtration device defines a radial direction and a circumferential direction. The housing includes a casing and a cap removably connected to the casing. The cap further includes a base wall having a top surface and a bottom surface opposite the top surface, the base wall defining a plurality of channels along the bottom surface and each channel extending along the radial direction. The cap also includes a circumferential rim projecting along the axial direction from the bottom surface of the base wall and disposed about the axial centerline along the circumferential direction, the circumferential rim including a sidewall extending in a plane along the axial direction and a flange extending in a plane along the radial direction, the circumferential rim defining a plurality of grooves each connecting with one of the channels.

In some exemplary embodiments, the filtration device further includes a membrane cover. The membrane cover includes an annular member disposed about the axial centerline along the circumferential direction, the annular member having an outer radial wall. The membrane cover further including a cover outlet port extending along the axial direction annularly about the axial centerline and the cover outlet port defining the outlet of the filtration device. The membrane cover also including one or more radial members extending radially inward along the radial direction toward the axial centerline and connecting the annular member with the cover outlet port. The membrane cover further including a plurality of projections extending from the outer radial wall of the annular member, each projection extending a plane along the axial direction and the circumferential direction, and wherein each of the projections is positioned within one of the grooves of the circumferential rim.

In some exemplary embodiments, the membrane cover further includes one or more locking housings projecting from the bottom surface of the annular member along the axial direction and extending along the circumferential direction, and wherein each locking housing defines a locking groove.

In some exemplary embodiments, the filter medium assembly further includes a membrane casing configured for receiving the filter medium. The membrane casing including a top circumferential wall disposed about the axial centerline along the circumferential direction; an outlet port extending along the axial direction annularly about the axial centerline, the outlet port defining the outlet of the filtration device; one or more radial members extending radially inward along the radial direction toward the axial centerline and coupling the top circumferential wall with the outlet port; and one or more locking members projecting radially outward from the top circumferential wall and extending along the circumferential direction. Each locking member of the membrane casing is configured to slide into one of the locking grooves of the membrane cover to secure the membrane casing with the membrane cover.

In some exemplary embodiments, the cover outlet port of the membrane cover is received within the outlet port of the membrane casing, and wherein the cap defines an opening in the base wall, and wherein the cover outlet port, the outlet port, and the opening in combination define the outlet of the filtration device.

In some exemplary embodiments, the filter medium extends along the axial direction annularly about the axial centerline between a top end and a bottom end, and wherein each mixed matrix membrane has a membrane inlet positioned at the top end of the filter medium for receiving a flow of fluid, and wherein each mixed matrix membrane dead-ends at the bottom end of filter medium.

In some exemplary embodiments, the filtration device defines an axial direction and an axial centerline extending along the axial direction, and wherein the filter medium extends along the axial direction annularly about the axial centerline between a top end and a bottom end, and wherein each mixed matrix membrane of the filter medium extends along the axial direction proximate the top end and converges radially inward toward the axial centerline along the radial direction proximate bottom end.

In some exemplary embodiments, the hollow fiber membranes are formed at least partially of at least one of polysulfone, polyvinyldiene, fluoride, polyacrylonitrile, and cellulose acetate.

In some exemplary embodiments, the one or more adsorbents include at least one of a granulated activated carbon, one or more nanoparticles, one or more carbon nanotubes, a metal organic framework, a graphene oxide, one or more zeolites, one or more organic additives, and one or more inorganic additives.

In another exemplary aspect, a filtration device for an appliance is provided. The filtration device includes a housing. The housing includes a casing defining an interior volume and a cap removably connected to the casing and defining an inlet for allowing a flow of liquid into the filtration device and defining an outlet for allowing a flow of liquid out of the filtration device. The filtration device further includes a filter medium assembly disposed within the interior volume of the casing. The filter medium assembly includes a membrane casing and a filter medium received within the membrane casing. The filter medium includes a potted medium and a plurality of mixed matrix membranes dispersed within the potted medium, each mixed matrix membrane having a membrane inlet in liquid communication with the inlet of the filtration device. The plurality of mixed matrix membranes include a plurality of hollow fiber membranes and one or more adsorbents embedded within each of the hollow fiber membranes.

In some exemplary embodiments, the filtration device defines an axial direction, a radial direction, and a circumferential direction, and an axial centerline extending along the axial direction, and wherein the filter medium extends along the axial direction annularly about the axial centerline between a top end and a bottom end, and wherein the filter medium defines an outlet volume extending along the axial centerline between the top end and the bottom end, and wherein a collection volume is defined annularly about the axial centerline between an inner surface of the casing and the filter medium assembly, and wherein the collection volume is in liquid communication with the outlet volume via an opening defined at the bottom end of the filter medium.

In some exemplary embodiments, the filtration device defines an axial direction, a radial direction, a circumferential direction, and an axial centerline extending along the axial direction, and wherein the cap further includes: a base wall having a top surface and a bottom surface opposite the top surface, the base wall including a plurality of ridges projecting from the bottom surface of the base wall, the ridges and the bottom surface defining a plurality of channels each extending along the radial direction and spaced apart from one another by one of the ridges along the circumferential direction; a circumferential rim projecting from the bottom surface of the base wall along the axial direction and disposed about the axial centerline along the circumferential direction, the circumferential rim including a sidewall extending in a plane along the axial direction and a flange extending in a plane along the radial direction and connected with the sidewall at an edge, the circumferential rim defining a plurality of grooves each connecting with one of the channels.

In some exemplary embodiments, the filtration device further includes a membrane cover. The membrane cover including: an annular member disposed annularly about the axial centerline and having an outer radial wall; a cover outlet port extending along the axial direction annularly about the axially centerline, the cover outlet port defining the outlet of the filtration device; one or more radial members extending radially inward along the radial direction toward the axial centerline and connecting the annular member with the cover outlet port; and a plurality of projections extending from the outer radial wall of the annular member, each projection extending a plane along the axial direction and the circumferential direction. Each of the projections is positioned within one of the grooves of the circumferential rim.

In some exemplary embodiments, the membrane cover further includes one or more locking housings projecting from the bottom surface of the annular member along the axial direction and extending along the circumferential direction, and wherein each locking housings defines a locking groove, and wherein the membrane casing includes: a top circumferential wall disposed about the axial centerline along the circumferential direction; an outlet port extending along the axial direction annularly about the axial centerline, the outlet port defining the outlet of the filtration device; one or more radial members extending radially inward along the radial direction toward the axial centerline and coupling the top circumferential wall with the outlet port; and one or more locking members projecting radially outward along the radial direction from the top circumferential wall and extending along the circumferential direction. Each locking member is configured to slide into one of the locking grooves of the membrane cover to secure the membrane casing with the membrane cover.

In some exemplary embodiments, the membrane casing includes a bottom wall having a concave interior shape.

In some exemplary embodiments, the filtration device defines an axial direction, a radial direction, and an axial centerline along the radial direction, and wherein the filtration device is configured such that the liquid flow through the mixed matrix membranes flows radially inward toward the axial centerline along the radial direction.

In some exemplary embodiments, the filtration device defines an axial direction, a radial direction, and an axial centerline along the radial direction, and wherein the filtration device is configured such that the liquid flow through the mixed matrix membranes flows radially outward away from the axial centerline along the radial direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary refrigerator appliance according to an exemplary embodiment of the present subject matter;

FIG. 2 provides a front view of the exemplary refrigerator appliance of FIG. 1 with refrigerator doors in an open position to show an exemplary filter assembly;

FIG. 3 provides a front, perspective view of an exemplary filtration device of the filter assembly of FIG. 2;

FIG. 4 provides an exploded view of the filtration device of FIG. 3;

FIG. 5 provides a perspective, cross-sectional view of the filtration device of FIG. 3 with the section taken on line A-A of FIG. 6;

FIG. 6 provides a top, perspective view of the filtration device of FIG. 3;

FIG. 7 provides a perspective view of the bottom side of an exemplary cap of the filtration device of FIG. 3;

FIG. 8 provides a close-up, perspective view of the cap of FIG. 7;

FIG. 9 provides a perspective view of an exemplary filtration medium assembly of the filtration device of FIG. 3;

FIG. 10 provides an exploded view of the filtration medium assembly of FIG. 9;

FIG. 11 provides a close-up, bottom looking up perspective view of exemplary membranes of the filtration device of FIG. 3 with the membranes cut along their respective axial lengths for illustrative purposes;

FIG. 12 provides a top view of the filtration device of FIG. 3 with the cap of the filtration device shown transparent for illustrative purposes;

FIG. 13 provides a perspective view of an exemplary membrane cover of the filtration device of FIG. 3 attached to a portion of an exemplary membrane casing;

FIG. 14 provides a perspective view of the bottom side of the membrane cover of FIG. 13;

FIG. 15 provides a close-up, cross-sectional view of an exemplary projection of the membrane cover positioned within an exemplary groove of the cap of the filtration device of FIG. 3;

FIG. 16 provides a side, cross-sectional view of the filtration device of FIG. 3 illustrating the flow of fluid therethrough taken along line A-A of FIG. 6;

FIG. 17 provides a close up view of fluid flowing into a membrane inlet of an exemplary mixed matrix membrane of the filtration device of FIG. 16;

FIG. 18 provides a perspective view of a filter medium of the filtration device of FIG. 3 illustrating the flow of fluid therethrough; and

FIG. 19 provides a perspective view of a filter medium of the filtration device of FIG. 3 illustrating another exemplary embodiment of the flow of fluid therethrough.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

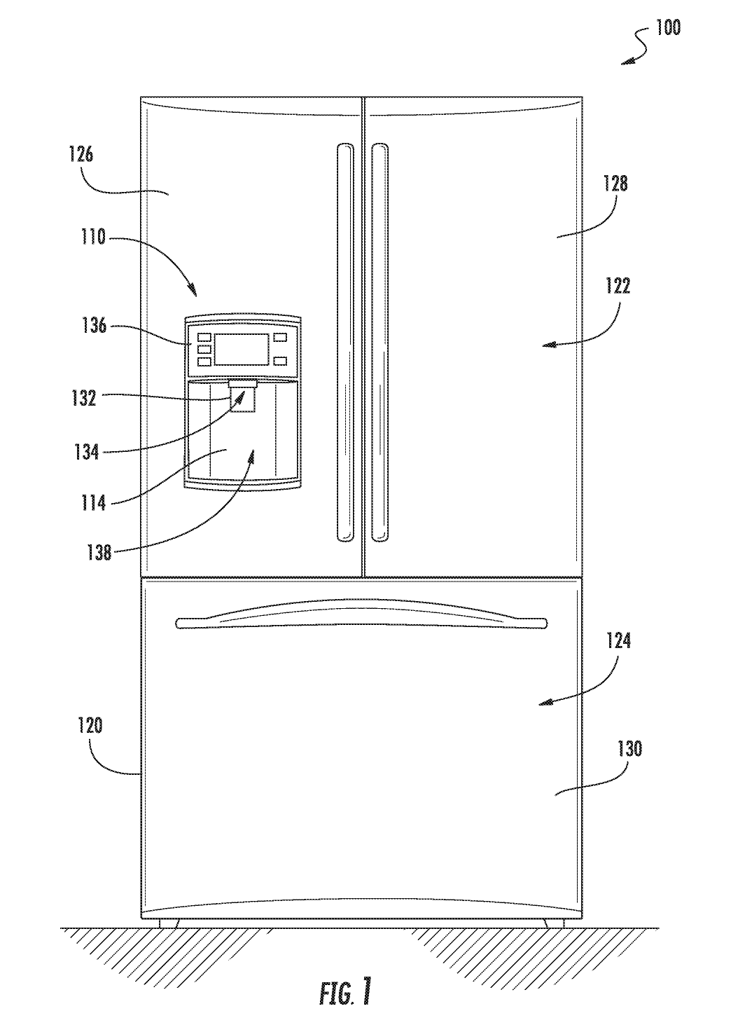

FIG. 1 provides a front view of an exemplary embodiment of a refrigerator appliance 100 as may be equipped with an exemplary fluid filter assembly of the present disclosure. However, as will be understood using the teachings disclosed herein, the fluid filter assembly (including the filter cartridge) disclosed herein may be used with other refrigerator appliance configurations (e.g., side-by-sides) as well as other types of appliances. It may also be used in applications other than appliances as well. For example, the filtering system of the present invention may be installed under a kitchen sink or as part of a whole housing filtration system. As such, refrigerator appliance 100 is provided only by way of example of an application of the exemplary fluid filter assembly of the present disclosure.

Refrigerator appliance 100 includes a cabinet or housing 120 defining an upper fresh food chamber 122 and a lower freezer chamber 124 arranged below the fresh food chamber 122. As such, refrigerator appliance 100 is generally referred to as a bottom mount refrigerator. In this exemplary embodiment, housing 120 also defines a mechanical compartment (not shown) for receipt of a sealed cooling system.

Refrigerator doors 126, 128 are rotatably hinged to an edge of housing 120 for accessing fresh food chamber 122. A freezer door 130 is arranged below refrigerator doors 126, 128 for accessing freezer chamber 124. In the exemplary embodiment, freezer door 130 is coupled to a freezer drawer (not shown) that is slidably mounted within freezer chamber 124.

Refrigerator appliance 100 includes a dispensing assembly 110 for dispensing water and/or ice. Dispensing assembly 110 includes a dispenser 114 positioned on an exterior portion of refrigerator appliance 100. Dispenser 114 includes a discharging outlet 134 for accessing ice and water. An activation member 132 is mounted below discharging outlet 134 for operating dispenser 114. In FIG. 1, activation member 132 is shown as a paddle. However, activation member 132 may be any other suitable mechanism for signaling or initiating a flow of ice and/or water into a container within dispenser 114, e.g., a switch or button. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and activation member 132 are an external part of dispenser 114, and are mounted in a recessed portion 138 defined in an outside surface of refrigerator door 126. Recessed portion 138 is positioned at a predetermined elevation convenient for a user to access ice or water and enabling the user to access ice without the need to bend-over and without the need to access fresh food chamber 122. In the exemplary embodiment, recessed portion 138 is positioned at a level that approximates the chest level of an adult user.

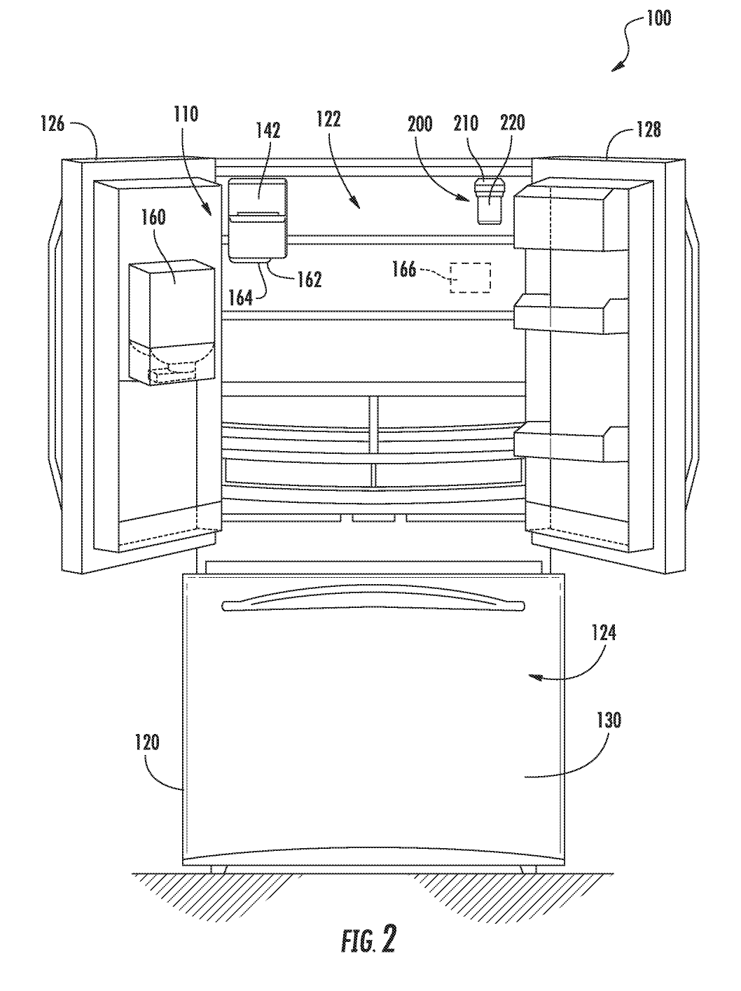

FIG. 2 provides a perspective view of refrigerator appliance 100 having refrigerator doors 126, 128 in an open position to reveal the interior of fresh food chamber 122. As such, certain components of dispensing assembly 110 are illustrated. Dispensing assembly 110 includes an insulated housing 142 mounted within chamber 122. Due to insulation surrounding insulated housing 142, the temperature within insulated housing 142 can be maintained at levels different from the ambient temperature in the surrounding fresh food chamber 122.

In particular, insulated housing 142 is constructed and arranged to operate at a temperature that facilitates producing and storing ice. Insulated housing 142 contains an ice maker (not shown) for creating ice and feeding the same to a receptacle 160 that is mounted on refrigerator door 126. As illustrated in FIG. 2, receptacle 160 is placed at a vertical position on refrigerator door 126 that will allow for the receipt of ice from a discharge opening 162 located along a bottom edge 164 of insulated housing 142 when refrigerator door 126 is in a closed position (shown in FIG. 1). As refrigerator door 126 is closed or opened, receptacle 160 is moved in and out of position under insulated housing 142.

Operation of the refrigerator appliance 100 is regulated by a controller 166 that is in communication with (or operatively coupled with) user interface panel 136 and/or activation member 132 (shown in FIG. 1). User interface panel 136 provides selections for user manipulation of the operation of refrigerator appliance 100 such as e.g., selections between whole or crushed ice, chilled water, and/or other options as well. In response to user manipulation of the user interface panel 136, controller 166 operates various components of the refrigerator appliance 100. Controller 166 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes programming instructions stored in memory. The memory may be a separate component from the processor or may be included onboard within the processor.

Controller 166 may be positioned in a variety of locations throughout refrigerator appliance 100 in addition to the location shown in FIG. 2. For example, controller 166 may be located within or beneath the user interface panel 136 on refrigerator door 126. In such embodiments, input/output (“I/O”) signals may be routed between the controller and various operational components of refrigerator appliance 100. In some exemplary embodiments, the user interface panel 136 may represent a general purpose I/O (“GPIO”) device or functional block. In other exemplary embodiments, the user interface 136 may include input components, such as one or more of a variety of electrical, mechanical or electro-mechanical input devices including rotary dials, push buttons, and touch pads. The user interface panel 136 may be in communication with the controller via one or more signal lines or shared communication busses.

As further shown in FIG. 2, refrigerator appliance 100 includes a filter assembly 200 that filters fluid (e.g., water) coming into refrigerator appliance 100 from a water supply (not shown), such as a municipal source or a well. Filter assembly 200 can remove contaminants and pollutants, such as e.g., chlorine, chloroform, cadmium, chromium, phenols, pharmaceuticals, microbes, cysts, heavy metals (e.g., lead), arsenic, and/or other undesirable substances, from fluid supplied to refrigerator appliance 100. As will be appreciated and as used herein, the term “fluid” includes purified water and solutions or mixtures containing water and, e.g., elements (such as calcium, chlorine, and fluorine), salts, bacteria, nitrates, organics, and other chemical compounds or substances.

Moreover, for the illustrated embodiment of FIG. 2, filter assembly 200 is shown positioned within fresh food chamber 122. However, filter assembly 200 can be located in other suitable locations, such as e.g., on the exterior of refrigerator 100, on a surface adjacent to refrigerator 100, connected to a water supply line (not shown) providing fluid to refrigerator 100, and/or other locations as well. In addition, as stated above, filter assembly 200 may also be located under a sink, configured as part of a whole house filtration system, or otherwise configured for other applications as well.

As further shown in FIG. 2, for this embodiment, filter assembly 200 includes a manifold 210 and a filtration device 220 removably connected to manifold 210. Manifold 210 includes a fluid inlet and a fluid outlet that are provided for a flow of unfiltered fluid into filter assembly 200 and a flow of filtered fluid out of filter assembly 200, respectively. The fluid inlet is adapted for coupling manifold 210 to a fluid supply system, such as e.g., the piping system within a user's dwelling that may be connected with a well or municipal water supply, and fluid outlet is adapted for coupling manifold 210 to the fluid supply system and/or, in some embodiments, to the ice maker within insulated housing 142 and/or discharging outlet 134. Fluid inlet and fluid outlet may be equipped with slip fittings, threads, fasteners, and/or other mechanisms for attachment. In this way, manifold 210 couples the fluid supply system with filtration device 220 such that the fluid supply system is in fluid communication with filtration device 220. Fasteners can secure filter assembly 200 to a wall, cabinet, or other surface. Other methods of attachment may also be used. Filter device 220 will be described in greater detail below.

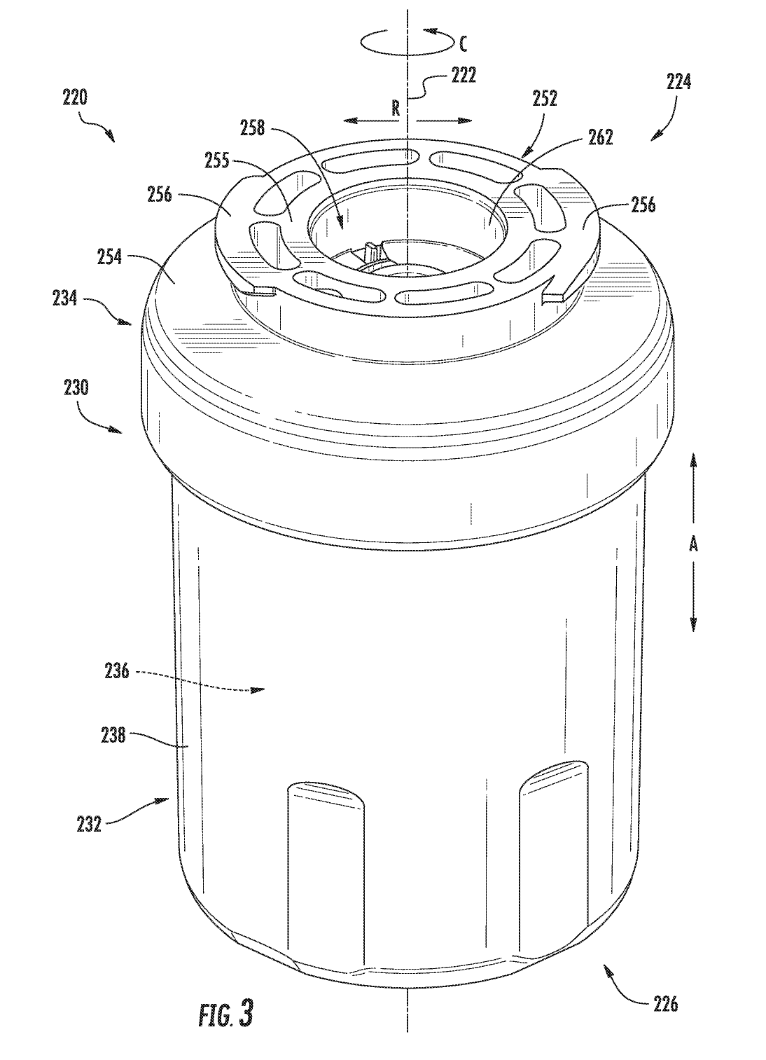

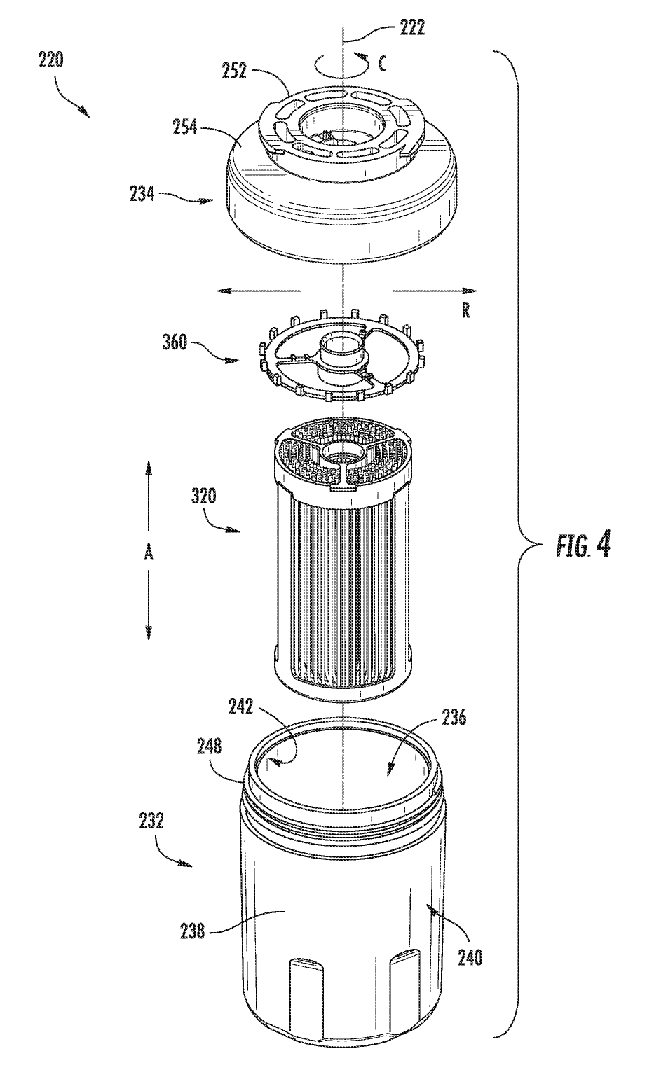

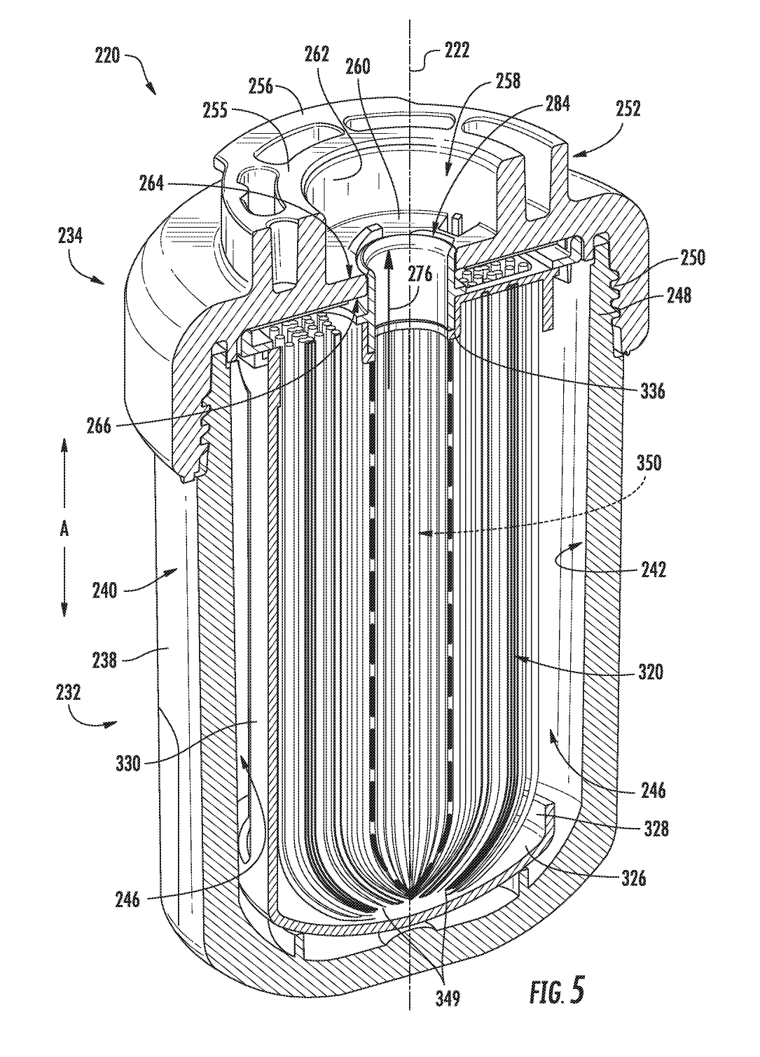

FIG. 3 provides a perspective view of filtration device 220 of the exemplary filter assembly 200 of FIG. 2 in an assembled configuration. FIG. 4 provides an exploded view of filtration device 220 and FIG. 5 provides a perspective, cross-sectional view thereof. As shown in FIGS. 3 and 4, filtration device 220 defines an axial direction A, a radial direction R, and a circumferential direction C extending about the axial direction A. Filtration device 220 also defines an axial centerline 222 extending along the axial direction A. Filtration device 220 extends along the axial direction A between a top portion 224 and a bottom portion 226 (FIG. 3). Moreover, as used herein, a radially inward direction is a direction toward the axial centerline 222 along the radial direction R and a radially outward direction is a direction away from or extending outward from the axial centerline 222 along the radial direction R.

As shown in FIGS. 3 and 4, for this embodiment, filtration device 220 includes a housing 230 that includes a casing 232 and a cap 234 removably connected with casing 232 (FIG. 3). Filtration device 220 also includes a filter medium assembly 320 and a membrane cover 360 (FIG. 3). Housing 230, filter medium assembly 320, and membrane cover 360 of filtration device 220 will each be discussed in turn.

With reference to FIGS. 3 through 5, housing 230 includes casing 232 and cap 234 removably connected with casing 232, as noted above. Casing 232 defines an interior volume or chamber 236 into which filter medium assembly 320 and membrane cover 360 are received (FIG. 4). For this embodiment, casing 232 defines a generally cylindrical chamber 236 for receiving the generally cylindrical filter medium assembly 320 and generally circular membrane cover 360. Casing 232 includes a sidewall 238 annularly disposed about the axial centerline 222. Sidewall 238 has an outer surface 240 and an inner surface 242 opposite outer surface 240. Inner surface 242 faces radially inward toward chamber 236 while outer surface 240 faces the exterior of filtration device 220.

As shown particularly in FIG. 5, when filter medium assembly 320 is inserted into casing 232, a collection volume 246 is defined between inner surface 242 of casing 232 and filter medium assembly 320. More specifically, collection volume 246 is defined annularly about the axial centerline 222 between inner surface 242 of casing 232 and the outer periphery of filter medium assembly 320. Collection volume 246, as will be described in greater detail herein, is configured to collect fluid circulating through filtration device 220 after it has been filtered.

Moreover, as shown in FIGS. 4 and 5, casing 232 includes a threaded portion 248 circumferentially disposed along outer surface 240 of the top portion of casing 232. Threaded portion 248 of casing 232 is configured to mate with a complementary threaded portion 250 of cap 234 (FIG. 5). To secure cap 234 to casing 232, cap 234 is rotated about the axial centerline 222 relative to casing 232 (or vice versa) such that threaded portion 248 of casing 232 mates in threaded engagement with threaded portion 250 of cap 234. In this way, casing 232 is removably connected to cap 234 (or vice versa) such that, for example, the filter medium of filter medium assembly 320 can be replaced or serviced when the efficacy of the filter medium has deteriorated beyond a predetermined threshold. In some alternative embodiments, cap 234 is not removably connected with casing 232; rather, cap 234 is permanently fixed or connected with or to casing 232. In such alternative embodiments, other means can be used to access the filter medium of filter medium assembly 320. For example, the bottom of casing 232 can include an access door.

Referring now to FIGS. 3 and 5, cap 234 of housing 230 includes a manifold interface 252 that secures filtration device 220, and more specifically cap 234 of filtration device 220, to manifold 210 (FIG. 2). For this embodiment, manifold interface 252 protrudes from a base portion 254 of cap 234 generally along the axial direction A and is annularly disposed about the axial centerline 222. Manifold interface 252 includes a flange 255 extending in a plane along the radial direction R and disposed annularly about the axial centerline 222. Flange 255 includes one or more radial projections 256 that project radially outward from flange 255 and extend along the circumferential direction C (FIG. 3). For this embodiment, flange 255 includes two radial projections 256 diametrically opposed to one another. Moreover, for this embodiment, to secure filtration device 220 with manifold 210, filtration device 220 is inserted into a receiving portion of manifold 210 and then rotated about the axial direction A. When filtration device 220 is rotated, radial projections 256 lock into engagement with their respective mating channels of manifold 210. In alternative embodiments, cap 234, and more broadly filtration device 220, can be secured to manifold 210 in other suitable ways, such as e.g., by one or more fasteners.

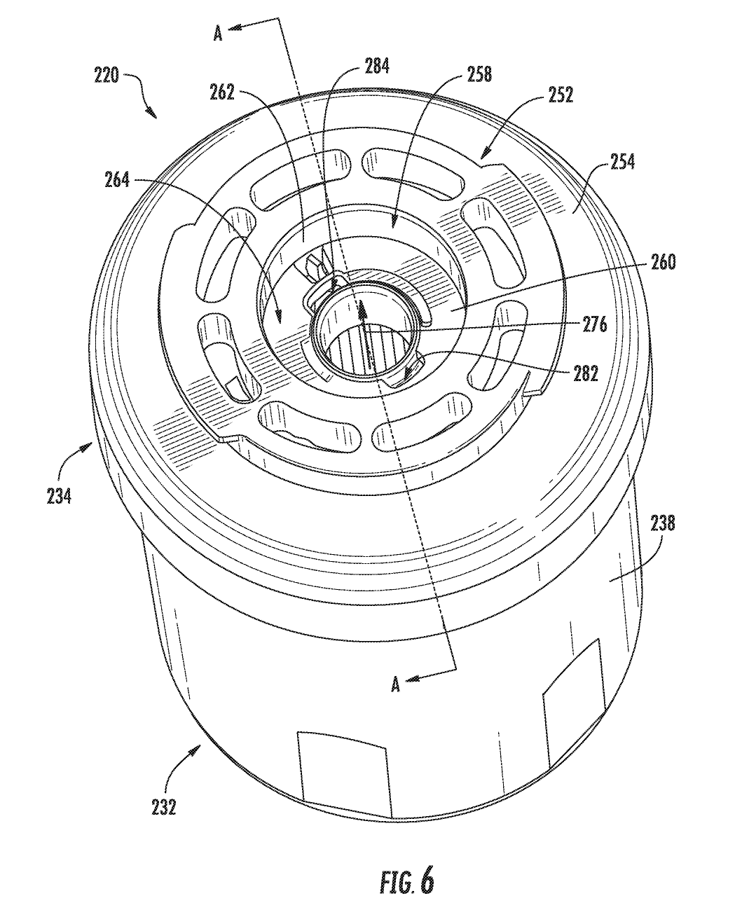

Referring now to FIGS. 5 and 6, FIG. 6 provides a top, perspective view of the exemplary filtration device 220 of FIG. 3. As shown, manifold interface 252 defines a recess 258. In particular, a base wall 260 and a sidewall 262 of manifold interface 252 define recess 258. Base wall 260 includes a top surface 264 and a bottom surface 266 opposite top surface 264 (FIG. 5).

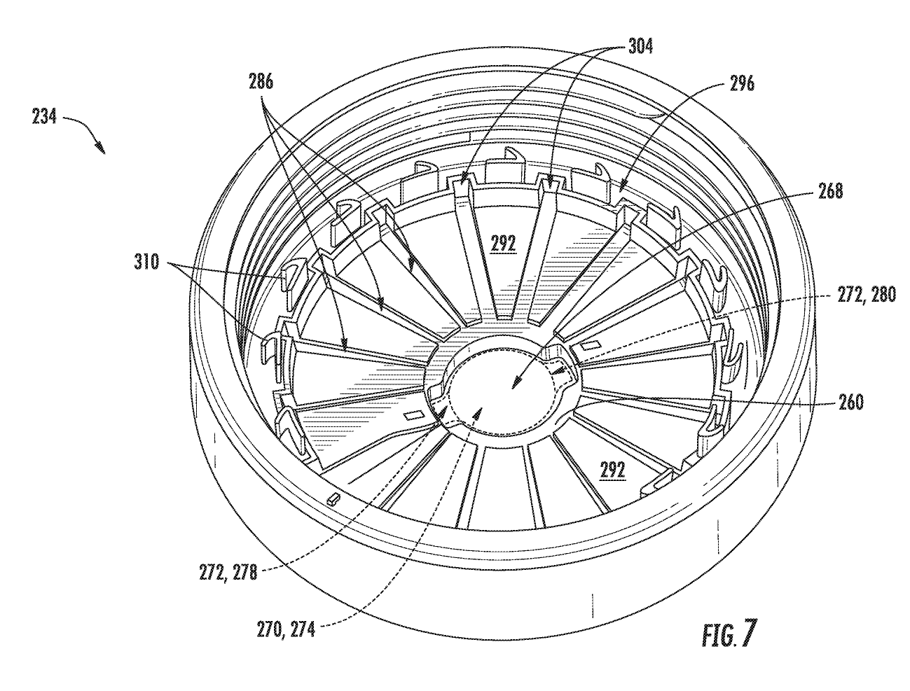

With reference now to FIGS. 5 through 7, FIG. 7 provides a bottom or underside, perspective view of cap 234. As shown particularly in FIG. 7, base wall 260 defines an opening 268 therethrough. Opening 268 is shown having a generally circular-shaped portion or outlet opening 274 with two diametrically opposed rectangular-shaped cutouts or first and second inlet openings 278, 280 contiguous with outlet opening 274 of opening 268. For this embodiment, as shown by the dashed lines in FIG. 7, the outlet opening 274 in cap 234 defines an outlet 276 of filtration device 220 (FIGS. 5 and 6). The first and second inlet openings 278, 280 in cap 234 define inlets, or for this embodiment, respective first and second inlets 282 284 of filtration device 220 (FIG. 6). First and second inlets 282, 284 are configured to allow a flow of unfiltered fluid into filtration device 220 while outlet 276 is configured to allow a flow of filtered fluid out of filtration device 220. In some exemplary embodiments, filtration device 220 can include one or more outlets and/or one or more inlets. In this way, filtration device 220 is not limited to the single outlet/duel inlet configuration shown in the illustrated embodiment of FIGS. 5 through 7.

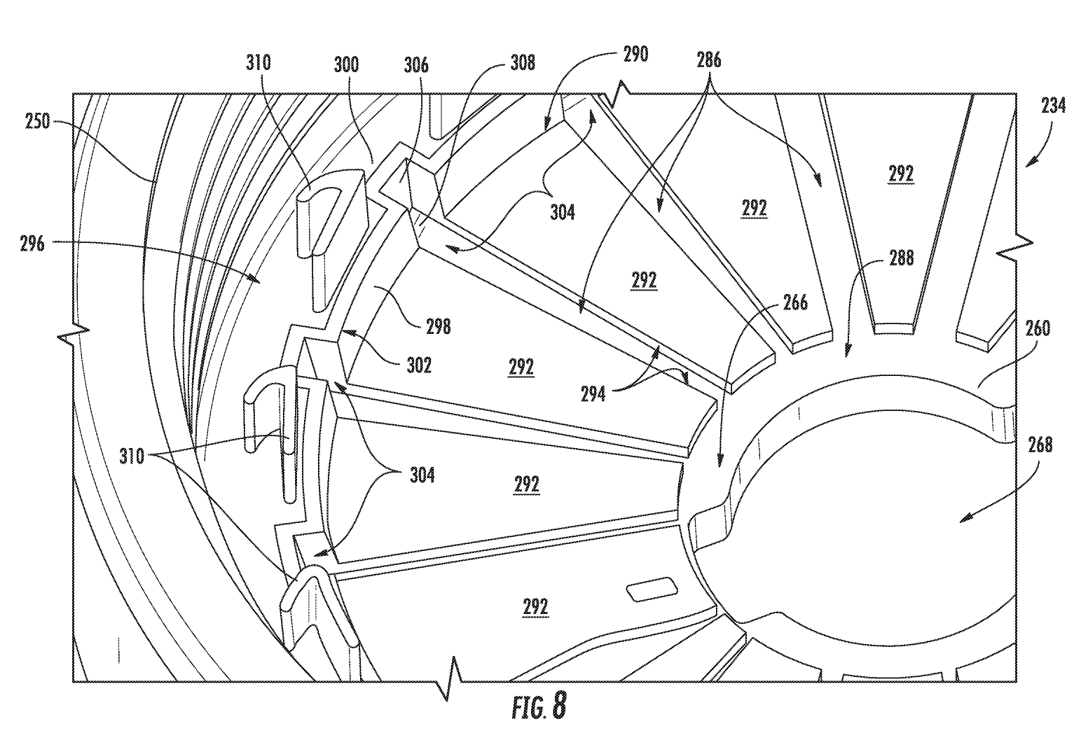

With reference now to FIGS. 7 and 8, FIG. 8 provides a close up view of the bottom or underside of cap 234 of FIG. 7. As shown, base wall 260 defines a plurality of channels 286. Each channel 286 extends along the radial direction R and is spaced apart from adjacent channels 286 along the circumferential direction C. In particular, as shown in FIG. 8, each channel 286 extends along the radial direction R from a radially inner position 288 of cap 234, or a position proximate the outer periphery of opening 268, to an outer periphery 290 of base wall 260. Moreover, each channel 286 is spaced apart from adjacent channels 286 by ridges 292. Ridges 292 protrude from bottom surface 266 along the axial direction A and form sidewalls 294 of each channel 286. As will be explained in further detail herein, after fluid enters filtration device 220 through first and/or second inlets 282, 284 (FIG. 6), the fluid flows in and around channels 286 and ridges 292 to fill in the annular space between radially inner position 288 proximate opening 268 and outer periphery 290 of base wall 260. Channels 286 ensure that the fluid flows into the entire annular space by providing the fluid a path of least resistance in a number of radial outward directions.

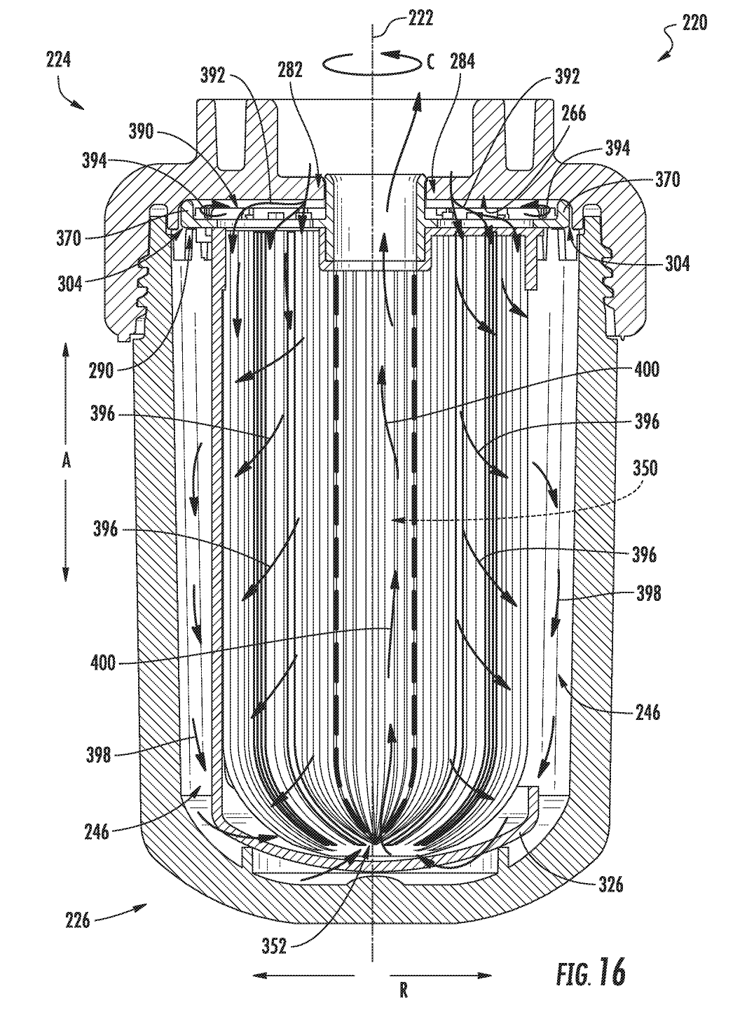

As further shown in FIG. 8, cap 234 includes a circumferential rim 296 disposed along outer periphery 290 of base wall 260. Circumferential rim 296 includes a sidewall 298 having a face extending in a plane along the axial direction A and a flange 300 having a face extending in a plane along the radial direction R. Flange 300 connects with sidewall 298 at an edge 302. For this embodiment, each channel 286 extends into sidewall 298 of circumferential rim 296. In this way, circumferential rim 296 defines a plurality of grooves 304. Stated alternatively, each channel 286 includes a grooved portion or groove 304 extending into and defining a void in circumferential rim 296. Moreover, each groove 304 defines an axial portion 306 and a radiused portion 308 (see FIG. 15). The face of the axial portion 306 extends in a plane along the axial direction A and radiused portion 308 transitions axial portion 306 into radially oriented bottom surface 266, which extends in a plane along the radial direction R.

Referring still to FIG. 8, flange 300 of circumferential rim 296 includes a plurality of stops 310 circumferentially spaced apart from one another along the circumferential direction C. Stops 310 prevent over torqueing of cap 234 on casing 232 such that membrane cover 360 and/or filter medium assembly 320 are not damaged during assembly/disassembly. Stops 310 may also assist in directing a flow of fluid through filtration device 220.

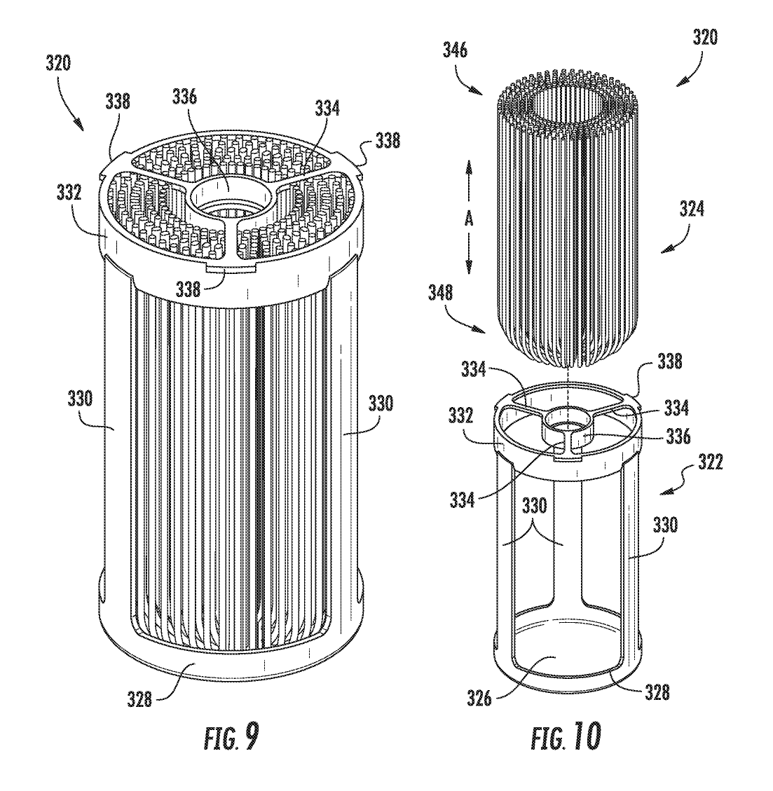

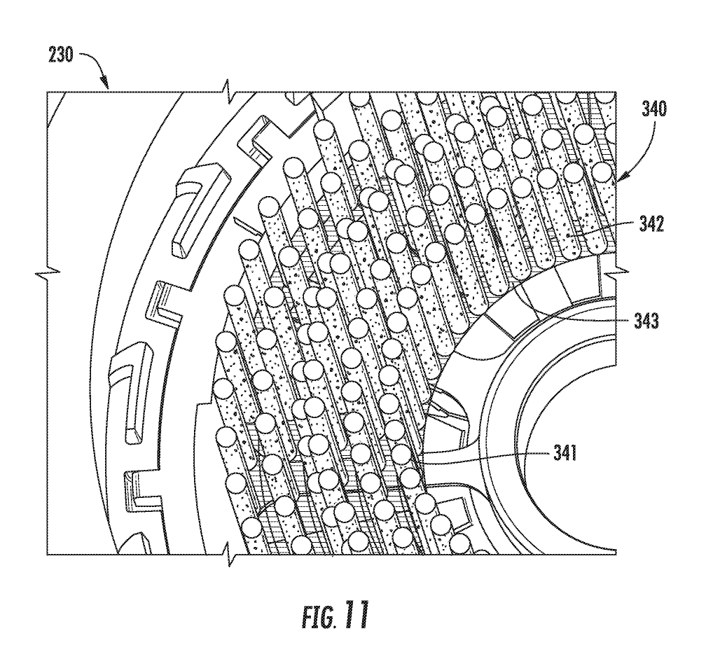

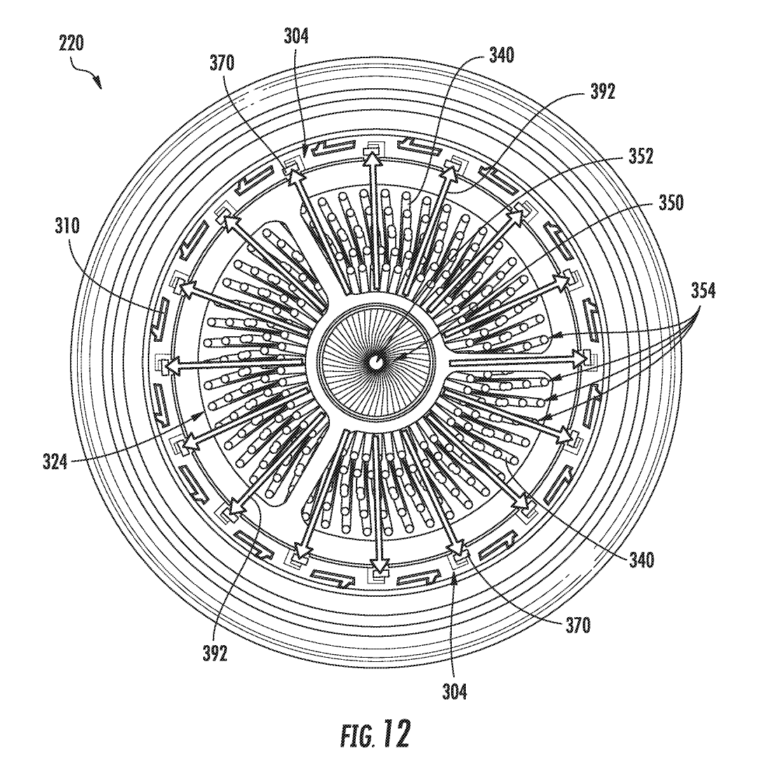

Referring now to FIGS. 9 through 11, filter medium assembly 320 will now be described. FIG. 9 provides a perspective view of filter medium assembly 320 of the exemplary filtration device 220 of FIG. 3 and FIG. 10 provides an exploded view thereof. FIG. 11 provides a close up, bottom looking top view of filter medium assembly 320 received within housing 230 of filtration device 220. As shown in FIG. 10, filter medium assembly 320 includes a membrane casing 322 configured to receive and structurally support a membrane bundle or filter medium 324.

As shown in FIGS. 9 and 10, membrane casing 322 includes a bottom wall 326 (FIG. 10). For this embodiment, bottom wall 326 has a generally concave interior shape (FIG. 5). Bottom wall 326 transitions into a bottom circumferential wall 328 disposed about the circumferential direction C along the perimeter of bottom wall 326 as shown in FIG. 10. Extending from bottom circumferential wall 328 are a plurality of axial members 330 that each extend along the axial direction A. Each axial member 330 connects bottom circumferential wall 328 with a top circumferential wall 332. Like bottom circumferential wall 328, top circumferential wall 332 is disposed about the axial centerline 222 along the circumferential direction C. For this embodiment, bottom circumferential wall 328 and top circumferential wall 332 have the same diameter. A plurality of radial members 334 extend radially inward from top circumferential wall 332 and connect to an outlet port 336. Outlet port 336 extends along the axial direction A annularly about the axial centerline 222 and has a thickness in the radial direction R. Outlet port 336 defines outlet 276 of filtration device 220 (FIG. 5). Moreover, as shown in FIG. 9, a plurality of locking members 338 project radially outward from a top portion of top circumferential wall 332. In particular, for this embodiment, locking members 338 project radial outward from top circumferential wall 332 opposite each radial member 334 projecting radially inward toward outlet port 336.

As shown in FIG. 11, for this embodiment, filter medium 324 includes a plurality of mixed matrix membranes 340. More particularly, for this embodiment, each mixed matrix membrane 340 includes a tubular, hollow fiber membrane 341 embedded with at least one adsorbent 342 (shown by the dots or specs on the hollow fiber membranes 341). The mixed matrix membranes 340 are dispersed within or embedded within, or potted within, a potted medium 343, such as e.g., a polyurethane resin, that fills the interstitial spaces between mixed matrix membranes 340 and provides structural robustness to filter medium 324.

Hollow fiber membranes 341 can be formed of any suitable porous or semipermeable material. For instance, hollow fiber membranes 341 can be formed of any suitable polymer or ceramic, such as e.g., polysulfone, polyvinyldiene, fluoride, polyacrylonitrile, cellulose acetate, etc. Hollow fiber membranes 341 can be any suitable type of membrane including, for example, a nanofiltration, ultrafiltration, or microfiltration membrane. Adsorbents 342 can be any suitable material with adsorbing capacity or capability, such as e.g., granulated activated carbon, nano particles, carbon nano tubes, metal organic framework, graphene oxide, zeolites, organic/inorganic additives, a combination of the foregoing, etc.

In some embodiments, during mixed matrix membrane synthesis, organic/inorganic adsorbents 342 are added to hollow fiber membranes 341 formed of a polymeric material. As one example, activated carbon (adsorbent) can be combined with polysulfone (hollow fiber membrane) such that phenols can be removed from unfiltered water circulating through filtration device 220. As another example, silver nanoparticles (adsorbent) can be combined with polyacrylonitrile (hollow fiber membrane) such that arsenic can be removed from unfiltered water circulating through filtration device 220. Multiple or combinations of adsorbents 342 can be embedded within the hollow fiber membranes 341 to provide versatile filtration characteristics to mixed matrix membranes 340. After embedding adsorbents 342 with hollow fiber membranes 341, the formed mixed membranes 340 can be cast to yield flat sheet membranes or spun to yield hollow fiber mixed matrix membranes as shown in FIGS. 9 through 11. The resulting mixed matrix membranes 340 retain the adsorbents 342 embedded in their structure. In this way, mixed matrix membranes 340 provide a dual level of filtration and flexibility for removing a variety of pollutants. In particular, mixed matrix membranes 340 provide size separation capacity for capturing a particular size of particle (i.e., mechanical filtration) and adsorbents 342 provide adsorbent-based filtration capacity for capturing particular types of particles (i.e., by adsorption). The dual level of filtration provided by mixed matrix membranes 340 makes filtration device 220 more versatile during filtration operation and can lead to a reduction in the Total Dissolved Solids (TDS) within the filtered water, or a reduction in a measure of all organic/inorganic substances (minerals), or a reduction in heavy metal content, or a reduction in any other harmful constituents (like arsenic, lead, etc.) that are dissolved in the water.

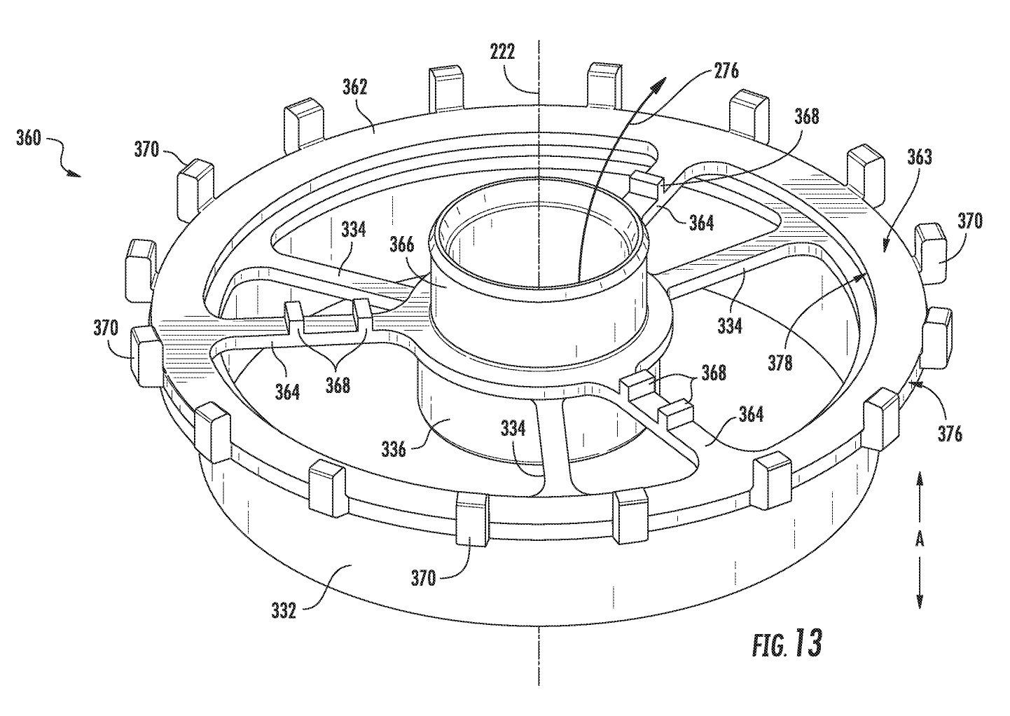

As shown further in FIGS. 5 and 10, each mixed matrix membrane 340 extends generally along the axial direction A between a top end 346 and a bottom end 348 of filter medium 324 (FIG. 10). However, as shown most clearly in FIG. 5, each mixed matrix membrane 340 transitions from a generally axial orientation along a portion of the axial length of the filter medium 324 to a curved radially inward orientation proximate bottom end 348 of filter medium 324. More specifically, proximate top end 346, mixed matrix membranes 340 are arranged generally annularly about the axial centerline 222 and define a generally cylindrical outlet volume 350 extending along the axial length of filter medium 324 along the axial centerline 222 of filtration device 220 (FIGS. 5 and 12). Proximate bottom end 348 of filter medium 324, mixed matrix membranes 340 converge radially inward toward axial centerline 222 and terminate in a dead-end configuration where ends 349 point radially inward towards centerline 222 (FIG. 5).

FIG. 12 provides a top view of the exemplary filtration device 220 of FIG. 3 with the top portion of cap 234 shown transparent for additional clarity. As shown, as mixed matrix membranes 340 converge radially inward proximate bottom end 348 (FIG. 10) of filter medium 324, outlet volume 350 is reduced in diameter. At bottom end 348 where mixed matrix membranes 340 converge in a dead-end configuration, filter medium 324 defines an opening 352 that provides fluid communication between collection volume 246 (FIG. 5) and outlet volume 350 (FIG. 5). In this way, filtered fluid collecting in collection volume 246 can exit filtration device 220 through outlet volume 350 and ultimately through outlet 276 of filtration device 220. As shown further in FIG. 12, at top end 346 (FIG. 10) of filter medium 324, each mixed matrix membrane 340 includes a membrane inlet 354 for receiving a flow of fluid (e.g. water). More particularly, for this embodiment, each membrane inlet 354 is configured for receiving a flow of unfiltered water.

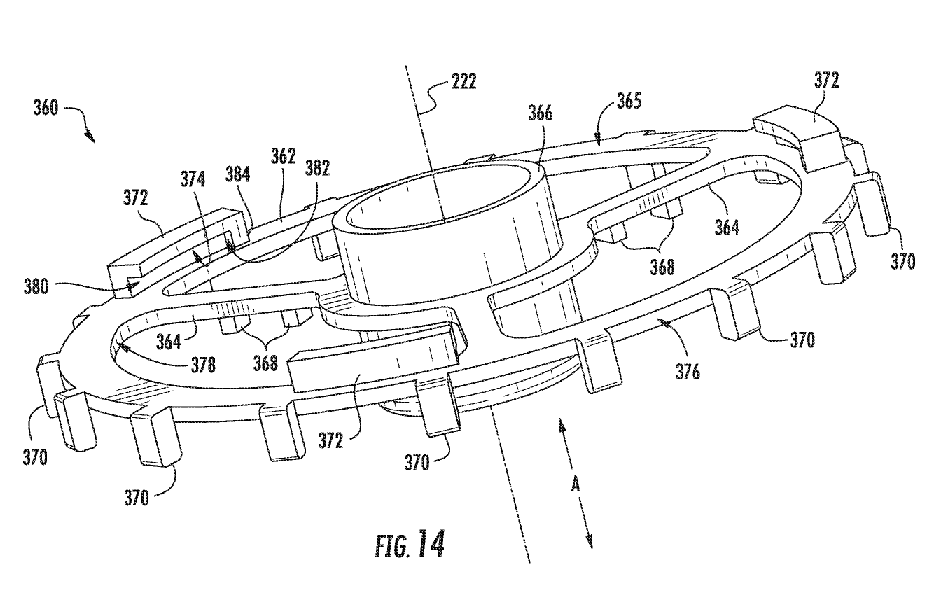

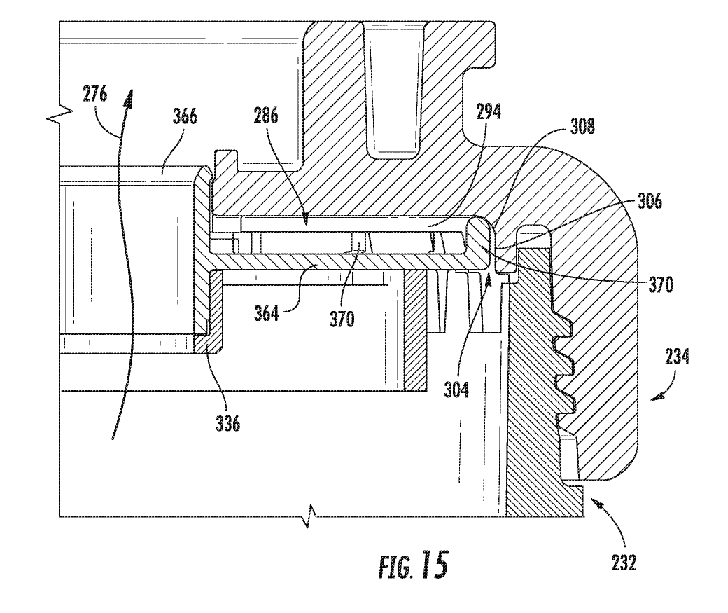

FIG. 13 provides a perspective view of an exemplary membrane cover 360 in mating engagement with circumferential wall 332 of membrane casing 322 of the exemplary filtration device 220 of FIG. 3. In FIG. 13, the remaining portions of membrane casing 322 are not shown. FIG. 14 provides a bottom, perspective view of the exemplary membrane cover 360 of FIG. 13. As shown in FIG. 13, membrane cover 360 includes an annular member 362 disposed about the axial centerline 222. Annular member 362 includes a top surface 363 and a bottom surface 365 (FIG. 14) opposite top surface 363. An outer radial wall 376 connects top surface 363 with bottom surface 365 at an outer periphery of annular member 362 and an inner radial wall 378 connects top surface 363 with bottom surface 365 at an inner portion of annular member 362. Annular member 362 is shaped generally complementary to top circumferential wall 332 of membrane casing 322. Membrane cover 360 includes a plurality of radial members 364 extending from annular member 362 radially inward toward a cover outlet port 366. Each radial member 364 includes one or more ribs 368. Ribs 368 provide structural rigidity and integrity to membrane cover 360. Cover outlet port 366, as shown in FIG. 13, is configured to mate with outlet port 336 of membrane casing 322. In particular, as shown with additional clarity in FIG. 5, cover outlet port 366 of membrane cover 360 is received within outlet port 336 of membrane casing 322. Cover outlet port 366 defines outlet 276 of filtration device 220.

As shown in FIG. 14, annular member 362 includes one or more locking housings 372 projecting from bottom surface 365 of annular member 362 along the axial direction A and extending along the circumferential direction C. For this embodiment, annular member 362 includes three (3) locking housings 372 circumferentially spaced apart from one another. Each locking housing 372 defines a respective locking groove 374. Each locking groove 374 extends generally along the circumferential direction C and has an open end 380 and a closed end 382. In particular, closed end 382 is closed off by a stop wall 384. Moreover, for this embodiment, each locking groove 374 is open to and faces the radially inward direction.

Each locking groove 374 is configured to receive a respective locking member 338 of membrane casing 322. That is, each locking member 338 of membrane casing 322 is configured to slide into a respective locking groove 374 to secure membrane cover 360 with membrane casing 320. In this way, filter medium assembly 320 can be connected or otherwise coupled to membrane cover 360. To ensure each locking member 338 of membrane casing 322 has been slid properly into its respective locking groove 374, an operator may slide locking member 338 into locking groove 374 until locking member 338 contacts stop wall 384.

Moreover, as further shown in FIGS. 13 and 14, annular member 362 includes a plurality of projections 370 circumferentially spaced apart from one another along the circumferential direction C. Each projection 370 generally extends or projects from outer radial wall 376 of annular member 362 in a plane along the axial and circumferential directions A, C and has a thickness along the radial direction R.

FIG. 15 provides a close-up, cross-sectional view of the exemplary filtration device 220 of FIG. 3. As shown in FIG. 15, each projection 370 is configured to be received within one of the grooves 304 of cap 234. In particular, one of the edges of projection 370 engages radiused portion 308 of groove 304. Projections 370 positioned within their respective grooves 304 prevent fluid from flowing into collection volume 246 to “short circuit” the filtered liquid with the unfiltered liquid as described more fully below.

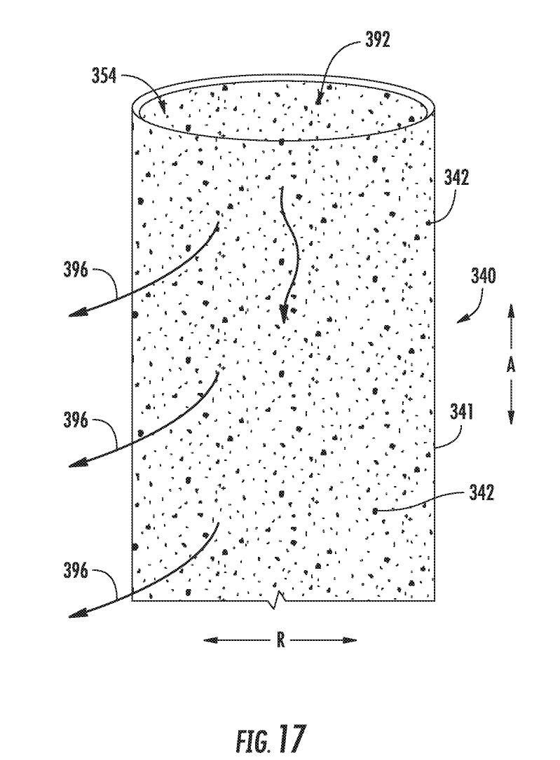

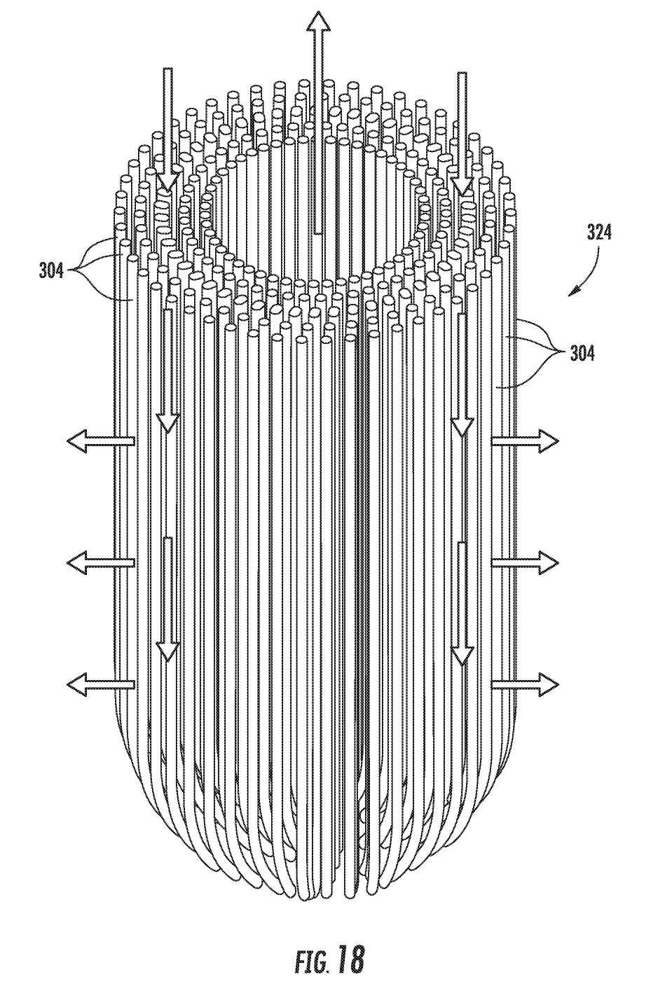

FIG. 16 provides a cross-sectional view of the exemplary filtration device 220 of FIG. 3 illustrating the flow of fluid (e.g., liquid) therethrough. FIG. 17 provides a close up view of fluid entering one of the mixed matrix membranes 340 of the exemplary filtration device 220 of FIG. 16 through its membrane inlet 354. As shown in FIG. 16, unfiltered fluid (e.g., water), denoted by arrows 392, enters through first and second inlets 282, 284. After entering through first and second inlets 282, 284, the fluid flows into an inlet volume 390 defined annularly about the axial centerline 222. More specifically, inlet volume 390 is defined along the axial direction A between bottom surface 266 of base wall 260 and filter medium assembly 320 and annularly about the axial centerline 222 between radially inner position 288 and outer periphery 290 of base wall 260 (FIG. 8). As the fluid flows into inlet volume 390, the fluid flows generally radially outward away from the axial centerline 222 along the radial direction R. Channels 286 (FIGS. 7 and 8) defined by bottom wall 260 provide the fluid with various paths of least resistance to better allow the fluid to fill in over the entire annularly disposed inlet volume 390 such that the fluid may fill in more evenly over the annularly disposed filter medium 324. A majority of the fluid enters filter medium 324 by flowing into each mixed matrix membrane 340 through their respective membrane inlet 354 (FIG. 12).

However, some of the fluid flows radially outward past filter medium 324 proximate outer periphery 290 within inlet volume 390. Projections 370 positioned within their respective grooves 304 prevent fluid from flowing into collection volume 246 (FIG. 15 provides a close up view of one projection 370 positioned within its respective groove 304). Stated alternatively, projections 370 prevent unfiltered fluid from mixing with filtered fluid collected in collection volume 246. As shown in FIG. 16, projections 370 cause the incoming fluid to retreat radially inward toward axial centerline 222, shown by arrows 394 in FIG. 16, such that the fluid can enter into mixed matrix membranes 340 for filtering.

For this embodiment, as shown more particularly in FIG. 17, as the fluid flows through the hollow fiber mixed matrix membranes 340 downward along the axial direction A, the fluid begins to permeate through mixed matrix membranes 340 radially outward along the radial direction R, denoted by arrows 396. Stated differently, for this embodiment, the fluid flows in-to-out. As the fluid passes through mixed matrix membranes 340, the hollow fiber membranes 341 of mixed matrix membrane 340 filters particles based on size (mechanical filtration) and adsorbents 342 embedded within hollow fiber membranes 341 filter the fluid via adsorption for capturing particular types of particles and pollutants, such as e.g., arsenic, cadmium, chromium, phenols, and other heavy metals and metalloids. In this way, mixed matrix membranes 340 provide a dual level of filtration.

Referring again to FIG. 16, after exiting through membranes 304, the now-filtered fluid is collected in collection volume 246, which is annularly disposed about the axial centerline 222 between inner surface 242 of casing 232 and filter medium assembly 320. The fluid stored in collection volume 246 is circulated (e.g. by pressure or gravity) axially downward toward bottom portion 226 of filtration device 220, as denoted by arrows 398. The filtered fluid then enters outlet volume 350 through opening 352 defined by filter medium 324. The filtered fluid then flows upward toward top portion 224 of filtration device 200 through outlet volume 350, denoted by arrows 400. Thereafter, filtered fluid exits filtration device 220 through outlet 276. As shown in FIG. 16, outlet 276 is defined by a combination of outlet port 336 of membrane casing 322, cover outlet port 366 of membrane cover 360, and opening 268 of cap 234. In this way, outlet port 336 partially defines outlet 276, cover outlet port 366 partially defines outlet 276, and opening 268 partially defines outlet 276. After the filtered fluid exits filtration device 220 through outlet 276, the filtered fluid flows through the fluid outlet of manifold 210 such that the filtered fluid can be delivered to one or more components of refrigerator appliance 100 and/or to another desirable location, such as e.g., a faucet in a bathroom of a user's dwelling.

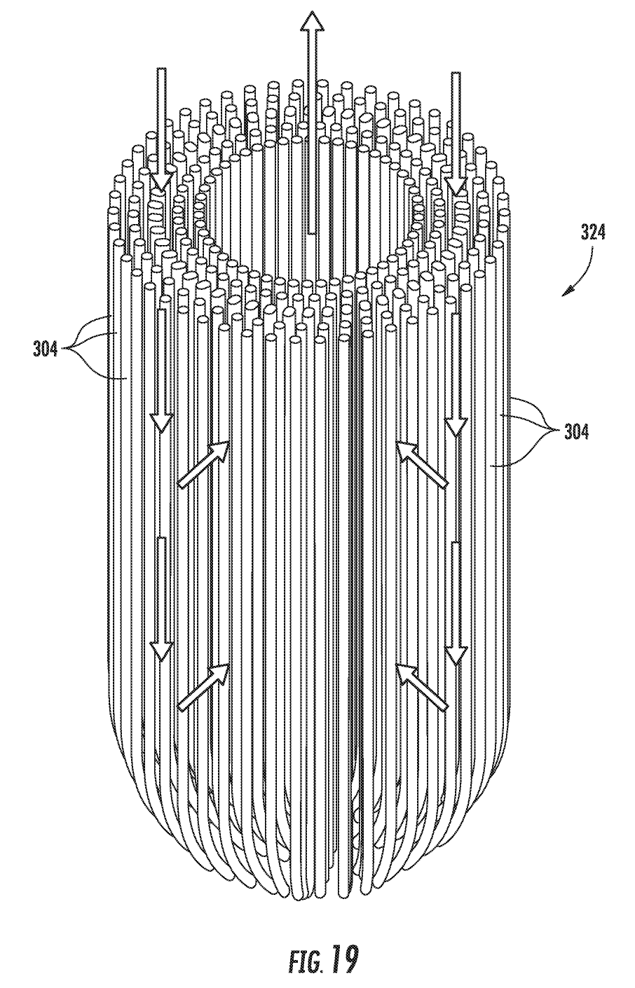

Referring now to FIGS. 18 and 19, FIG. 18 provides a perspective view of filter medium 324 illustrating one exemplary fluid flow pattern through filter medium 324 and FIG. 19 provides a perspective view of another exemplary filter medium 324 illustrating another exemplary fluid flow pattern through filter medium 324. As membranes 304 are not granular in nature, the flow of fluid through filtration device 220 can be optimized for the particular application. That is, by using membranes 304 as the filter medium, the direction of fluid flow through filter medium 324, and more broadly filtration device 324, is not limited to one particular flow direction. For example, for the illustrated embodiment of FIG. 19, the fluid flow through filter medium 324 is configured to flow from out-to-in. Stated alternatively, unfiltered fluid enters membranes 304 and flows radially inward toward axial centerline 222 such that the fluid may be filtered. In contrast, for the illustrated embodiment of FIG. 18, the fluid is configured to flow through filter medium 324 from in-to-out. Stated differently, filtered fluid enters membranes 304 and flows radially outward away from axial centerline 222 such that the fluid may be filtered. The flexibility of membranes 304 allows for an increased number of suitable structural designs of filtration device 220, among other potential advantages.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A filtration device for an appliance, the filtration device defining an axial direction and an axial centerline extending along the axial direction, comprising:
a housing defining an interior volume and defining an inlet for allowing a flow of fluid into the filtration device and defining an outlet for allowing a flow of fluid out of the filtration device; and
a filter medium assembly disposed within the interior volume of the housing and having a filter medium in fluid communication with the inlet and the outlet, the filter medium extending between a top end and a bottom end along the axial direction, the filter medium comprising:
a potted medium;
a plurality of mixed matrix membranes dispersed within the potted medium, comprising:
a plurality of hollow fiber membranes; and
one or more adsorbents embedded within the hollow fiber membranes;
wherein each mixed matrix membrane extends along the axial direction a portion of a length of the filter medium and each mixed matrix membrane converges along the radial direction toward the axial centerline proximate the bottom end.

2. The filtration device of claim 1, wherein the filtration device defines a radial direction and a circumferential direction, and wherein the housing comprises:
a casing;
a cap removably connected to the casing, the cap further comprising:
a base wall having a top surface and a bottom surface opposite the top surface, the base wall defining a plurality of channels along the bottom surface and each channel extending along the radial direction; and
a circumferential rim projecting along the axial direction from the bottom surface of the base wall and disposed about the axial centerline along the circumferential direction, the circumferential rim including a sidewall extending in a plane along the axial direction and a flange extending in a plane along the radial direction, the circumferential rim defining a plurality of grooves each connecting with one of the channels.

3. The filtration device of claim 2, wherein the filtration device further comprises:
a membrane cover, comprising:
an annular member disposed about the axial centerline along the circumferential direction, the annular member having an outer radial wall;
a cover outlet port extending along the axial direction annularly about the axial centerline and the cover outlet port defining the outlet of the filtration device;
one or more radial members extending radially inward along the radial direction toward the axial centerline and connecting the annular member with the cover outlet port; and
a plurality of projections extending from the outer radial wall of the annular member; each projection extending a plane along the axial direction and the circumferential direction;
wherein each of the projections is positioned within one of the grooves of the circumferential rim.

4. The filtration device of claim 3, wherein the membrane cover further includes one or more locking housings projecting from the bottom surface of the annular member along the axial direction and extending along the circumferential direction, and wherein each locking housing defines a locking groove.

5. The filtration device of claim 4, wherein the filter medium assembly further comprises:
a membrane casing configured for receiving the filter medium, wherein the membrane casing comprises:
a top circumferential wall disposed about the axial centerline along the circumferential direction;
an outlet port extending along the axial direction annularly about the axial centerline, the outlet port defining the outlet of the filtration device;
one or more radial members extending radially inward along the radial direction toward the axial centerline and coupling the top circumferential wall with the outlet port; and
one or more locking members projecting radially outward from the top circumferential wall and extending along the circumferential direction;
wherein each locking member of the membrane casing is configured to slide into one of the locking grooves of the membrane cover to secure the membrane casing with the membrane cover.

6. The filtration device of claim 5, wherein the cover outlet port of the membrane cover is received within the outlet port of the membrane casing, and wherein the cap defines an opening in the base wall, and wherein the cover outlet port, the outlet port, and the opening in combination define the outlet of the filtration device.

7. The filtration device of claim 1, wherein the filter medium extends along the axial direction annularly about the axial centerline between a top end and a bottom end, and wherein each mixed matrix membrane has a membrane inlet positioned at the top end of the filter medium for receiving a flow of fluid, and wherein each mixed matrix membrane dead-ends at the bottom end of filter medium.

8. The filtration device of claim 1, wherein the filtration device defines an axial direction and an axial centerline extending along the axial direction, and wherein the filter medium extends along the axial direction annularly about the axial centerline between a top end and a bottom end, and wherein each mixed matrix membrane of the filter medium extends along the axial direction proximate the top end and converges radially inward toward the axial centerline along the radial direction proximate bottom end.

9. The filtration device of claim 1, wherein the hollow fiber membranes are formed at least partially of at least one of polysulfone, polyvinyldiene, fluoride, polyacrylonitrile, and cellulose acetate.

10. The filtration device of claim 1, wherein the one or more adsorbents include at least one of a granulated activated carbon, one or more nanoparticles, one or more carbon nanotubes, a metal organic framework, a graphene oxide, one or more zeolites, one or more organic additives, and one or more inorganic additives.

11. A filtration device for an appliance, comprising:
a housing comprising:
a casing defining an interior volume;
a cap removably connected to the casing and defining an inlet for allowing a flow of liquid into the filtration device and defining an outlet for allowing a flow of liquid out of the filtration device;
a filter medium assembly disposed within the interior volume of the casing, the filter medium assembly comprising:
a membrane casing;
a filter medium received within the membrane casing, the filter medium comprising:
a potted medium;
a plurality of mixed matrix membranes dispersed within the potted medium, each mixed matrix membrane having a membrane inlet in liquid communication with the inlet of the filtration device, the plurality of mixed matrix membranes comprising:
a plurality of hollow fiber membranes;
one or more adsorbents embedded within each of the hollow fiber membranes.

12. The filtration device of claim 11, wherein the filtration device defines an axial direction, a radial direction, and a circumferential direction, and an axial centerline extending along the axial direction, and wherein the filter medium extends along the axial direction annularly about the axial centerline between a top end and a bottom end, and wherein the filter medium defines an outlet volume extending along the axial centerline between the top end and the bottom end, and wherein a collection volume is defined annularly about the axial centerline between an inner surface of the casing and the filter medium assembly, and wherein the collection volume is in liquid communication with the outlet volume via an opening defined at the bottom end of the filter medium.

13. The filtration device of claim 11, wherein the filtration device defines an axial direction, a radial direction, a circumferential direction, and an axial centerline extending along the axial direction, and wherein the cap further includes:
a base wall having a top surface and a bottom surface opposite the top surface, the base wall including a plurality of ridges projecting from the bottom surface of the base wall, the ridges and the bottom surface defining a plurality of channels each extending along the radial direction and spaced apart from one another by one of the ridges along the circumferential direction;
a circumferential rim projecting from the bottom surface of the base wall along the axial direction and disposed about the axial centerline along the circumferential direction, the circumferential rim including a sidewall extending in a plane along the axial direction and a flange extending in a plane along the radial direction and connected with the sidewall at an edge, the circumferential rim defining a plurality of grooves each connecting with one of the channels.

14. The filtration device of claim 13, wherein the filtration device further comprises:
a membrane cover, comprising:
an annular member disposed annularly about the axial centerline and having an outer radial wall;
a cover outlet port extending along the axial direction annularly about the axially centerline, the cover outlet port defining the outlet of the filtration device;
one or more radial members extending radially inward along the radial direction toward the axial centerline and connecting the annular member with the cover outlet port; and
a plurality of projections extending from the outer radial wall of the annular member, each projection extending a plane along the axial direction and the circumferential direction;
wherein each of the projections is positioned within one of the grooves of the circumferential rim.

15. The filtration device of claim 14, wherein the membrane cover further includes one or more locking housings projecting from the bottom surface of the annular member along the axial direction and extending along the circumferential direction, and wherein each locking housings defines a locking groove, and wherein the membrane casing comprises:
a top circumferential wall disposed about the axial centerline along the circumferential direction;
an outlet port extending along the axial direction annularly about the axial centerline, the outlet port defining the outlet of the filtration device;
one or more radial members extending radially inward along the radial direction toward the axial centerline and coupling the top circumferential wall with the outlet port; and
one or more locking members projecting radially outward along the radial direction from the top circumferential wall and extending along the circumferential direction;
wherein each locking member is configured to slide into one of the locking grooves of the membrane cover to secure the membrane casing with the membrane cover.

16. The filtration device of claim 11, wherein the membrane casing includes a bottom wall having a concave interior shape.

17. The filtration device of claim 11, wherein the filtration device defines an axial direction, a radial direction, and an axial centerline along the radial direction, and wherein the filtration device is configured such that the liquid flow through the mixed matrix membranes flows radially inward toward the axial centerline along the radial direction.

18. The filtration device of claim 11, wherein the filtration device defines an axial direction, a radial direction, and an axial centerline along the radial direction, and wherein the filtration device is configured such that the liquid flow through the mixed matrix membranes flows radially outward away from the axial centerline along the radial direction.
